(19) United States
(12) Patent Application Publication
(10) Pub. No.: US 2020/0410083 A1
(43) Pub. Date: Dec. 31, 2020

(54) CONTROLLING USE OF INFORMATION SUBMITTED TO COMPUTING SYSTEMS

(71) Applicant: International Business Machines Corporation, Armonk, NY (US)

(72) Inventors: Antonietta Fidanza, Pomezia (IT); Leonardo Rosati, Roma (IT); Antonio Mangiacotti, Pomezia (IT); Matteo Figoni, Rome (IT)

(21) Appl. No.: 16/452,991

(22) Filed: Jun. 26, 2019

(51) Int. Cl. G06F 21/44; G06F 21/30; G06F 21/62; G06F 21/78

(52) U.S. Cl. CPC G06F 21/44; G06F 21/78; G06F 21/6245; G06F 21/305

(57) ABSTRACT

A method for controlling use of information is proposed. The method comprises detecting relevant information contained in information submitted to a primary computing system, determining one or more secondary computing systems which may receive the relevant information from the primary computing system, and controlling the use of the relevant information by the primary/secondary computing system accordingly. A computer program and a computer program product for performing the method are also proposed. Moreover, a control computing system for implementing the method is proposed.

### BACKGROUND

The present disclosure relates to the information technology field. More specifically, this disclosure relates to the use of information in computing systems.

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Use of information (stored in computing systems) is a key issue in several contexts. Particularly, whenever the information is particularly relevant for corresponding owners, it is important to control that this (relevant) information is used correctly. A typical example is personal information, that is, information relating to identifiable persons. Indeed, the dissemination of personal information to third parties may involve threats to a privacy of the corresponding persons; for example, the personal information may be used for purposes that are annoying (for example, spamming) or even dangerous (for example, stalking).

Therefore, most countries have privacy laws which limit the use of the personal information; for example, in the European Union this is prescribed by the General Data Protection Regulation (GDPR). As a general rule, the privacy laws provide any person the right to control how and to what extent the corresponding personal information is used. For example, this requires a consent to be explicitly given by the person to authorize every use of the personal information; particularly, a specific consent is necessary to authorize a third party (to which the personal information has been submitted by the person) to share the personal information with other third parties transferring them the same authorization to use the personal information. Therefore, whenever a person submits personal information to any third party, s/he is asked to accept corresponding privacy terms authorizing the third party to use, and possibly to share, the personal information (for example, by filling and signing a corresponding form). Moreover, the person is generally allowed to access the personal information and to know how it is used; particularly, this includes the possibility of knowing the third parties, if any, with which the personal information has been shared. Generally, the person has the right to withdraw the consent to use the personal information at any time; particularly, this includes the possibility of requesting the erasure of the personal information by any third parties to which it has been submitted.

The widespread diffusion of the Internet poses several concerns about the privacy of the persons accessing it. Indeed, nowadays most persons use the Internet to perform many activities routinely (for example, to buy goods, to exploit functionalities, to find information and so on). Very often, the persons submit personal information to corresponding service providers, for example, when a registration thereto is required. Therefore, the persons have to accept the corresponding privacy terms as above. In this case, the acceptance of the privacy terms is performed on-line, for example, by ticking corresponding options in a web page.

However, especially in the Internet, many persons accept the privacy terms almost automatically, without really paying attention to the authorizations that are granted. Indeed, the acceptance of the privacy terms is required so often that generally the persons do not read them, and let alone carefully (since the operation is quite annoying); moreover, when the privacy terms are accepted on-line, it hardly gives the awareness of a legally binding action.

This results in a massive dissemination of the personal information to a very high number of third parties. Moreover, when the privacy terms are accepted on-line, no physical receipt is provided in response to the acceptance of the privacy terms (and substantially no person prints out the corresponding on-line forms). Therefore, the persons hardly remember the (very high number) of third parties which have been authorized to use the personal information.

Particularly, very often the persons have authorized the third parties to share the personal information submitted thereto with other third parties, which are simply indicated as such (and not identified individually). Therefore, it is very difficult, if not impossible, for the persons tracking the sharing of the personal information by the third parties authorized to do so.

As a consequence, very common the persons receive unsolicited messages (for example, advertisements) from third parties which are completely unknown, without understanding how they have managed to acquire their personal information.

All of the above adversely affects the possibility of controlling the use of the personal information in an effective way. Particularly, this hinders the possibility of exerting the rights that are provided by law for limiting the use of the personal information (for example, to withdraw the consent to use it).

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of tracking the authorizations to use the personal information.

Particularly, an embodiment provides a method for controlling use of information. The method comprises detecting relevant information contained in information submitted to a primary computing system, determining one or more secondary computing systems which may receive the relevant information from the primary computing system, and controlling the use of the relevant information by the primary/secondary computing system accordingly.

A further aspect provides a computer program for implementing the method.

A further aspect provides a corresponding computer program product.

A further aspect provides a corresponding control computing system.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

According to an aspect of the present invention, there is a method, computer program product and/or system that performs the following operations (not necessarily in the following order): (i) for each given primary computing system of a plurality of primary computing systems, granting a use authorization to the given primary computing system, with the use authorization including a definition of relevant information to which the use authorization is applicable and any authorization(s) to transfer the first use authorization to a secondary computing system of a plurality of secondary computing systems; (ii) for each given use authorization of the plurality of use authorizations respectively corresponding to the plurality of primary computing systems, storing the given use authorization in a control memory structure included in a control computing system; and (iii) controlling, by the control computing system, use of information by the plurality of primary computing systems and the plurality of secondary computing systems according to the use authorizations stored in the control memory structure.

### BRIEF DESCRIPTION OF THE SEVERAL VIEWS OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, like value, content and representation). Particularly:

FIG. 1A-FIG. 1D show an example of application of the solution according to an embodiment of the present disclosure,

FIG. 2 shows a schematic block diagram of an information technology infrastructure wherein the solution according to an embodiment of the present disclosure may be practiced,

FIG. 3 shows the main software components that may be used to implement the solution according to an embodiment of the present disclosure, and

FIG. 4A-FIG. 4C show an activity diagram describing the flow of activities relating to an implementation of the solution according to an embodiment of the present disclosure.

### DETAILED DESCRIPTION

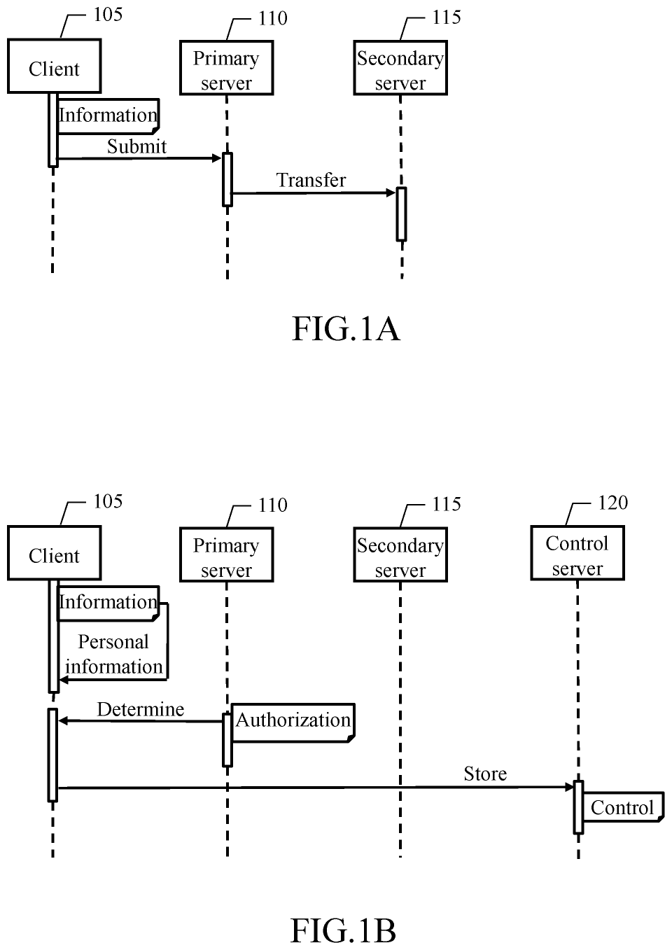

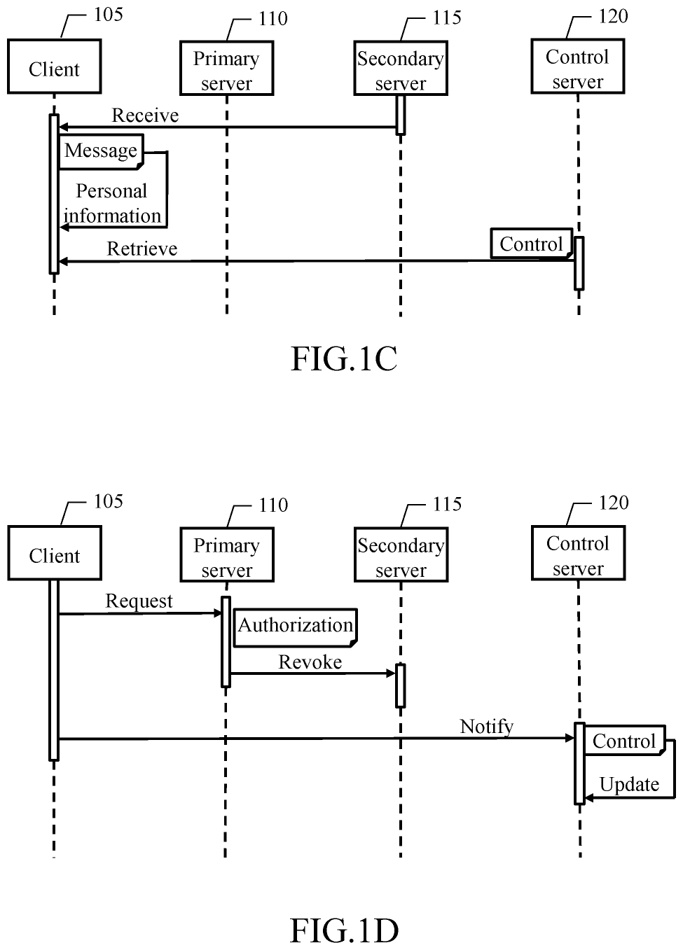

With reference in particular to FIG. 1A-FIG. 1D, an example is shown of application of the solution according to an embodiment of the present disclosure.

Starting from FIG. 1A, persons use corresponding client computing systems, or simply client 105 to access one or more server computing systems, or primary server 110 offering corresponding services, for example, in the Internet (only one for each of them being shown in the figure). Generally, the person submits information required to exploit each service to the corresponding primary server 110 (for example, to obtain a loan from a bank); this may include personal information of the person (for example, name, surname, birth date, fiscal code and so on). A third party associated with the primary server 110 (that is, the bank in the example at issue) is authorized to use the personal information and to transfer a corresponding use authorization to other third parties associated with one or more further (secondary) servers 115, only one shown in the figure (for example, insurance companies, investment funds and so on). These use authorizations are granted by the person accepting corresponding privacy terms (for example, by ticking corresponding options), either together with the submission of the personal information or at a different time (for example, in a same web page or previously during a corresponding registration process).

Moving to FIG. 1B, in the solution according to an embodiment of the present disclosure, the presence of the personal information (among all the information submitted by the client 105 to the primary server 110) is detected, for example, according to corresponding labels of input fields wherein the information is entered and/or according to a content of the information itself. In response thereto, the secondary servers 115 associated with the primary sever 110 are determined from an authorization memory structure (for example, stored in the primary server 110). An indication of the primary server 110 and of the corresponding secondary servers 115 (for example, their network addresses), and an indication of the personal information (for example, their types) are stored into a control memory structure, for example, in a control server computing system, or simply control server 120.

Moving to FIG. 1C, the use of the personal information is then controlled according to the control memory structure. For example, after a while the person receives a message, for example, an e-mail on the same client 105, from a (sender) server, for example, the secondary server 115. In response thereto, the message is analyzed to detect a presence of personal information therein. If so, the indication of a primary server associated with this personal information and with the secondary server 115, for example, the same primary server 110, is retrieved from the control memory structure (stored in the service server 120).

Moving to FIG. 1D, if the person does not want to receive messages from the secondary server 115, the person (via the client 105) requests the primary server 110 to revoke the use authorization from the secondary server 115. Accordingly, the primary server 110 requests the secondary server 115 to do so. At the same time, the client 105 notifies the control server 120 that the use authorization to the secondary server 115 has been revoked. As a result, the control server 120 updates the control memory structure accordingly.

The above-described solution significantly improves the possibility of controlling the use of the personal information in an effective way.

This is especially true when unsolicited messages (for example, advertisements) are received from third parties that are unknown, without understanding how they have managed to acquire corresponding personal information. Indeed, the proposed solution tracks the sharing of the personal information by the third parties that have been authorized to do so. Therefore, when a message is received from any (unknown) sender server, it is possible to find out the primary server which has been authorized to share the personal information with it and then to react accordingly.

Particularly, this makes it much easier to exert the rights that are provided by law for limiting the use of the personal information. For example, the person may now withdraw the consent to use the personal information by any primary/secondary servers, even when s/he does not remember how they have been authorized to do so.

The desired result may be achieved even when the person has accepted the corresponding privacy automatically (without really paying attention to the authorizations that are granted).

All of the above is especially important when the personal information is disseminated massively to a very high number of third parties (for example, in the Internet).

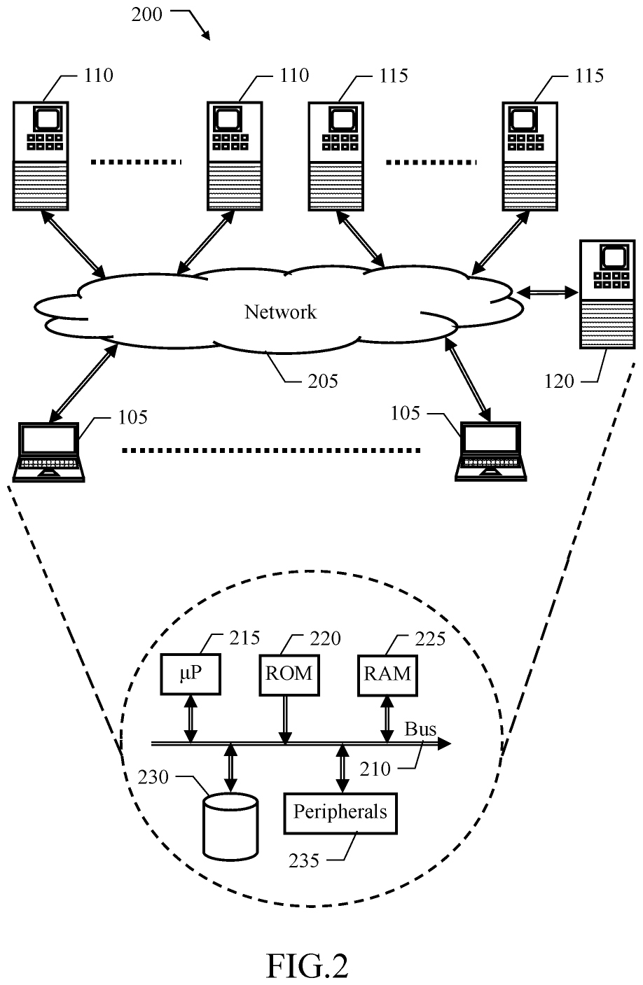

With reference now to FIG. 2, a schematic block diagram is shown of an information technology infrastructure 200 wherein the solution according to an embodiment of the present disclosure may be practiced.

The information technology infrastructure 200 comprises the clients 105, the primary servers 110, the secondary servers 115 and the control server 120 (generically called computers 105-120). The computers 105-120 communicate over a (telecommunication) network 205. For example, the information technology infrastructure 200 is based on the Internet. In this case, the (primary/secondary/service) servers 115-120 are web servers which are connected one to another through the network 205 being of global type; the clients 105 access the Internet (through corresponding access providers, not shown in the figure), in order to exploit services offered by it, and particularly by the primary server 110 as far as relevant to the present disclosure. For example, the primary server 110 allows accessing corresponding web sites providing banking, insurance, booking, social, travel and so on services.

Each one of the computers 105-120 includes several units that are connected among them through a bus structure 210 with one or more levels (with an architecture that is suitably scaled according to the type of the computer 105-120). Particularly, one or more microprocessors (μP) 215 control operation of the computer 105-120; a non-volatile memory (ROM) 220 stores basic code for a bootstrap of the computer 105-120 and a volatile memory (RAM) 225 is used as a working memory by the microprocessors 215. The computer 105-120 is provided with a mass-memory 230 for storing programs and data (for example, hard disks for the clients 105 and storage devices of corresponding data centers wherein the (primary/secondary/control) servers 110-120 are implemented). Moreover, the computer 105-120 includes a number of controllers for peripherals, or Input/Output (I/O) units, 235; for example, the peripherals 235 of each client 105 comprise a keyboard, a mouse, a monitor, a network adapter (NIC) for connecting to the network 205 and a drive for reading/writing removable storage units (such as optical disks like DVDs), whereas the peripherals 235 of each server 110-120 comprise a network card for plugging the server 110-120 into the corresponding data center and then connecting it to a console of the data center for its control (for example, a personal computer, also provided with a drive for reading/writing removable storage units as above) and to a switch/router sub-system of the data center for its communication with the network 205.

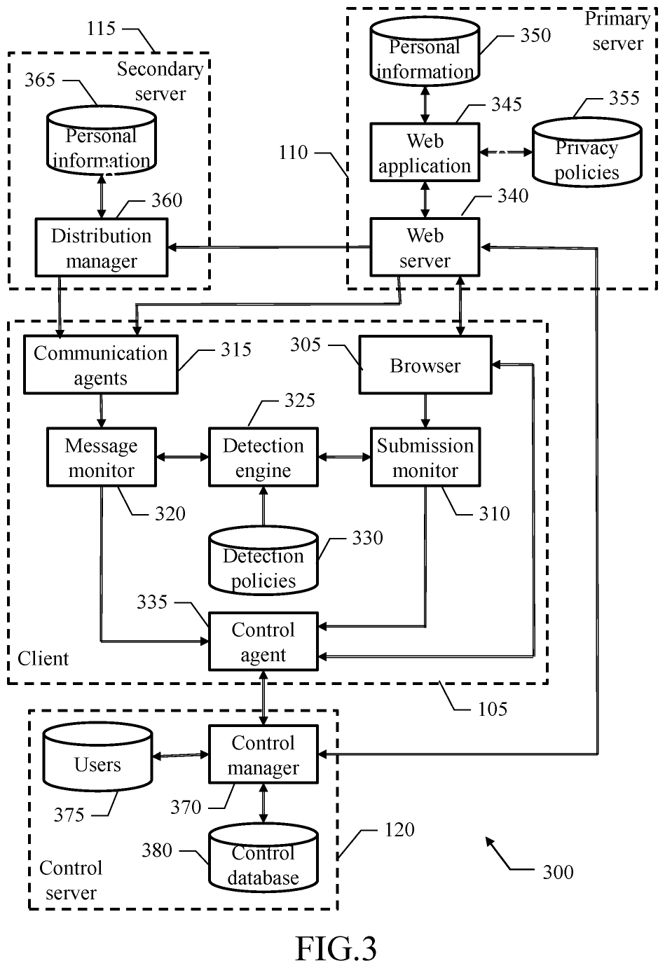

With reference now to FIG. 3, the main software components are shown that may be used to implement the solution according to an embodiment of the present disclosure.

Particularly, all the software components (programs and data) are denoted as a whole with the reference 300. The software components 300 are typically stored in the mass memories and loaded (at least in part) into the working memories of the computers 105-120 when the programs are running. The programs are initially installed into the mass memories, for example, from removable storage units or from the network (not shown in the figure). In this respect, each program may be a module, segment or portion of code, which includes one or more executable instructions for implementing the specified logical function.

Starting from each of the clients 105 (only one shown in the figure), it includes the following components. A browser 305 is used to surf the Internet; as far as relevant to the present disclosure, the browser 305 is used to access the primary server 110 for exploiting the corresponding services. A submission monitor 310 intercepts any information that is submitted by the browser 305 to the primary server 110 (interacting with it accordingly). One or more communication agents 315 are used to exchange messages (for example, comprising an e-mail agent, an instant message agent, an SMS agent and so on); as far as relevant to the present disclosure, the communication agents 315 are used to receive messages from the secondary servers 115 and from the primary server 110. A message monitor 320 intercepts any message that is received from the (primary/secondary) servers 110, 115 by the communication agents 315 (interacting with them accordingly). Both the submission monitor 310 and the message monitor 320 exploit a detection engine 325. The detection engine 325 is used to detect the presence of personal information (of a user of the client 105) in the information which is submitted or received. The detection engine 325 accesses (in read mode) a detection policy repository 330 defining how to detect the personal information (which detection policy repository 330 is maintained up-to-date by the control server 120). The detection policy repository 330 stores one or more entries for corresponding detection policies. Each detection policy includes a (type) identifier of a personal information type (for example, “name”, “surname”, “fiscal code”, “telephone number”, “e-mail address”, “credit card number” and so on). The detection policy then includes a reference label or a reference rule. The reference label qualifies information with which it is associated as personal information of the corresponding type; for example, the reference label is a name commonly used to indicate this type of personal information (such as “telephone number”, “mobile number” and “personal number” for the personal information type “telephone number”). The reference rule qualifies information satisfying it as personal information of the corresponding type; for example, the reference rule is defined by a dictionary (such as for the personal information type “name” or “surname”), a regular expression (such as for specific patterns, like of the personal information type “fiscal code”, “e-mail address”, “credit card number”) and so on. A control agent 335 controls the use of the personal information of the user. The control agent 335 may be activated by either the submission monitor 310 or the message monitor 320; moreover, it interacts with the browser 305.

Moving to each primary server 110 (only one shown in the figure), it includes the following components. A web server 340 manages any communication with the primary server 110, particularly, by processing any request submitted thereto by the browser 305 of the clients 105. The web server 340 interacts with a web application 345 implementing the service offered by the primary server 110; for example, the web application 345 provides a front-end for users of the clients 105 registered with the primary server 110. The web application 345 accesses (in read/write mode) a personal information database 350 for the personal information of the users which has been submitted to the primary server 110 authorizing its use. The personal information database 350 stores an entry for each user. The entry includes a user identifier (for example, his/her e-mail address), the corresponding personal information and the use authorization which has been granted by the user (that is, only for the primary server 110 or for the secondary servers 115 associated with it as well) and a network address (for example, its domain name) of each secondary server 115 to which the use authorization has been transferred by the primary server 110. Moreover, the web application 345 accesses (in read mode) a privacy policy repository 355 defining the privacy policies implemented by the primary server 110. As far as relevant to the present disclosure, the privacy policy repository 355 implements the above-mentioned authorization memory structure. The privacy policy repository 355 stores one or more entries for the secondary servers 115 to which the use authorization may be transferred by the primary server 110. Each entry includes a network address of the secondary server 115 (for example, its domain name) and a descriptor thereof (for example, a name of its third party).

Moving to each secondary server 115 (only one shown in the figure), it includes the following components. A distribution manager 360 controls the distribution of messages, particularly to the clients 105 (for example, advertisements for the third party of the secondary server 115). The distribution manager 360 accesses (in read/write mode) a personal information database 365 for the personal information of the users whose use authorization has been transferred to the secondary server 115. The personal information database 365 stores an entry for each user. The entry includes the user identifier, the corresponding personal information and a network address (for example, its domain name) of the primary server 110 from which the corresponding use authorization has been transferred. The distribution manager 360 communicates with the web server 340 of the primary server 110 and with the communication agents 315 of the clients 105.

Moving to the control sever 120 it includes the following components. A control manager 370 manages the control of the use of the personal information of the users of the clients 105. The control manager 370 communicates with the control agent 335 of the clients 105 and with the web server 340 of the primary server 110. Moreover, the control manager 370 accesses (in read/write mode) a user database 375 and a control database 380, which implement the above-mentioned control memory structure. Particularly, the user database 375 defines the users of the clients 105 (registered with the control server 120). The user database 375 includes an entry for each user. The entry stores the user identifier of the user and one or more client identifiers of his/her clients 105 (for example, their MAC addresses). The control database 380 defines the use authorizations which have been granted by the users. The control database 380 includes an entry for each use authorization. The entry stores the user identifier of the user which has granted the use authorization, the network address and a descriptor (for example, a name of its third party) of the primary server 110 to which the use authorization has been granted, the type identifiers of the personal information whose use has been authorized, the network address and the descriptor of each secondary server 115 (if any) to which the use authorization may be transferred by the primary server 110 and a time-stamp of the use authorization. Moreover, the entry includes a confirmation flag for the primary server and for each secondary server; the confirmation flag, when asserted, indicates that the corresponding use authorization has been (further) confirmed by the user.

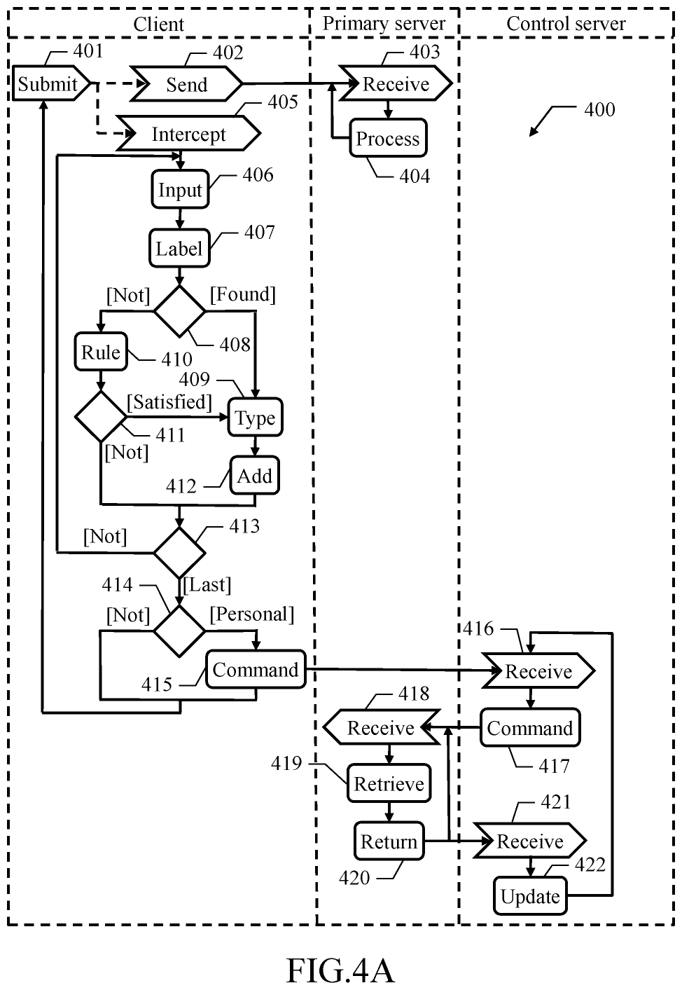

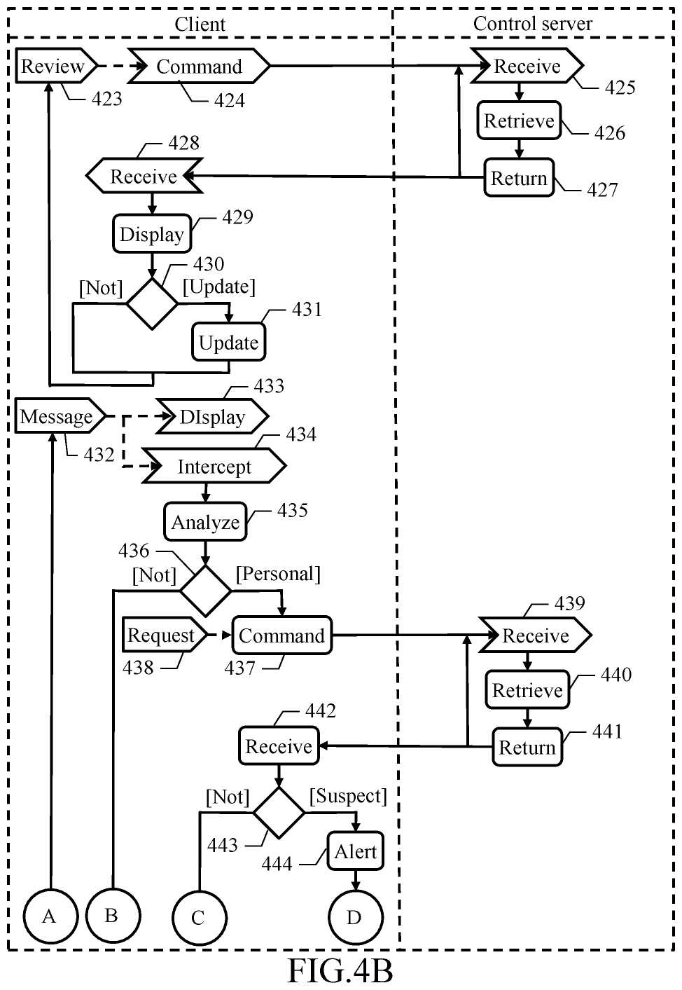

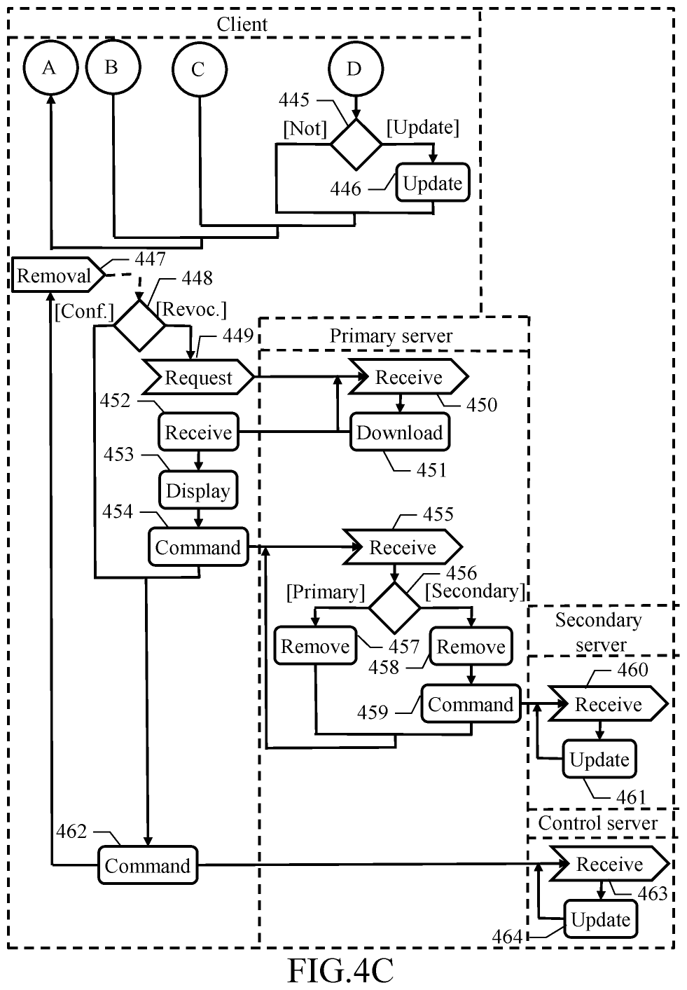

With reference now to FIG. 4A-FIG. 4C, an activity diagram is shown describing the flow of activities relating to an implementation of the solution according to an embodiment of the present disclosure.

Particularly, the activity diagram represents an exemplary process that may be used to control the use of personal information with a method 400. In this respect, each block may correspond to one or more executable instructions for implementing the specified logical function on the above-mentioned computers.

Starting from the swim-lane of a generic client, the process enters block 401 whenever its user submits any information to a generic primary server via the browser. For example, the user has accessed the primary server to download a web page therefrom. The web page defines an (on-line) submission form comprising one or more input fields with corresponding input labels (describing the information to be entered therein). The user fills in the submission form by entering the required information into the input fields, and then clicks a submit button. In response thereto, the browser at block 402 sends a corresponding submission command to the primary server (comprising the information being entered in the submission form). Moving to the swim-lane of the primary server, the web application at block 403 receives the submission command (via the web server). The web application at block 404 processes the submission command as usual. As far as relevant to the present disclosure, when the information contained in the submission command includes personal information of the user (with acceptance of corresponding privacy terms, provided at the same time or with another submission command), the web application updates the personal information database accordingly. Particularly, the web application adds the personal information and the corresponding use authorization (based on the accepted privacy terms) to the entry of the user (indicated by his/her user identifier, for example, entered during a log-in to the primary server). The process then returns to the block 403 waiting for a next submission command from the clients.

With reference again to the swim-lane of the client, in the solution according to an embodiment of the present disclosure the submission monitor at block 405 intercepts the submission command (for example, with hooking techniques). A loop is then entered by the submission monitor that commands the detection engine to analyze the information contained in the submission command against the detection policies (as indicated in the corresponding repository). The loop beings at block 406, wherein the detection engine takes a (current) input field of the submission form into account (starting from a first one in any arbitrary order). The detection engine at block 407 verifies whether the input label of the input field matches any of the reference labels. The flow of activity branches at block 408 according to a result of this verification. If a reference label is found in the input label, meaning that the input label matches the corresponding (matched) detection policy, the process descends into block 409 (described in the following). Conversely, when no reference label is found in the input label, the detection engine at block 410 verifies whether the information entered in the input field matches any of the reference rules. The flow of activity branches at block 411 according to a result of this verification. If the information satisfies a reference rule, meaning that the information matches the corresponding (matched) detection policy, the process again passes to the block 409. With reference now to the block 409, in both cases the information being entered in the input field is determined to be personal information of the user. Therefore, the detection engine retrieves the type identifier comprised in the matched detection policy, which then indicates the type of this personal information. For example, when the information has been entered in an input field with the input label “mobile number” it should be the telephone number of the user, when the information is found in a dictionary of personal names it should be the name of the user, when the information has the pattern of a fiscal code it should be the fiscal code of the user, and so on. The detection engine at block 412 adds the type identifier so determined to a personal information list (initially empty), which indicates the personal information types that have been submitted to the primary server. The process then descends into block 413. The same point is also reached from the block 411 if the information does not satisfy any of the reference rules (meaning that the information is not personal information of the user). At this point, the detection engine verifies whether a last input field of the submission form has been processed. If not, the flow of activity returns to the block 406 to repeat the same operations on a next input field of the submission form. Conversely (once all the input fields of the submission form have been processed), the loop is exit by descending into block 414.

The flow of activity now branches according to a content of the personal information list. If the personal information list is not empty, meaning that personal information has been submitted to the primary server, the submission monitor at block 415 commands the control agent to build a corresponding addition command for the control server. The addition commands includes a client identifier (for example, retrieved from a register of the client), the network address of the primary server (determined according to the submission command being intercepted), the personal information list, a time-stamp (for example, taken when the submission command has been intercepted) and a transfer flag; the transfer flag, when asserted, indicates that the primary server is authorized to share the personal information with other third parties (as determined according to the corresponding privacy terms being accepted). The control agent then sends the addition command to the control server. In this way, no personal information is shared with the control server.

Moving to the swim-lane of the control server, the control manager at block 416 receives the addition command from the client (and it extracts the client identifier, the network address of the primary server, the personal information list, the time-stamp and the transfer flag). The control manager at block 417 builds a retrieval command for the primary server, which retrieval command includes the transfer flag; the control manager then sends the retrieval command to the primary server. Moving to the swim-lane of the primary server, the web application at block 418 receives the retrieval command from the control server, via the web server (and it extracts the transfer flag). The web application at block 419 retrieves the descriptor of the primary server (for example, from a configuration parameter) and, if the transfer flag is asserted, the network addresses and the descriptors of the secondary servers associated therewith (from the privacy policy database). The web application at block 420 builds a retrieval response containing the information so retrieved and sends it back to the control server. The process then returns to the block 418 waiting for a next retrieval command from the control server. With reference again to the swim-lane of the control server, the control manager at block 421 receives the retrieval response from the primary server (and it extracts the descriptor of the primary server and the possible network addresses and descriptors of the secondary servers). The control manager at block 422 updates the control database accordingly. Particularly, the control manager retrieves the user identifier associated with the client identifier (from the user database). The control manager then adds the network address of the primary server, the descriptor of the primary server, its confirmation flag (deasserted), the type identifiers, the time-stamp, the possible network addresses, descriptors and confirmation flags (deasserted) of the secondary servers to the entry of the user identifier in the control database. In this way, the use of the personal information of the user may be controlled independently of its clients. The process then returns to the block 416 waiting for a next addition command from the clients.

In a completely independent way, the control agent at block 423 receives a review request entered manually by the user for reviewing his/her use authorizations. In response thereto, the control agent at block 424 builds a corresponding review command for the control server, which review command includes the client identifier of the client (retrieved as above); the control agent then sends the review command to the control server. Moving to the swim-lane of the control server, the control manager at block 425 receives the review command from the client (and it extract the client identifier). The control manager at block 426 retrieves the user identifier associated with the client identifier (from the user database). The control manager then builds a corresponding review response. The review response contains control information comprising the entries of the control database relating to the user identifier. The control manager at block 427 sends the review response back to the client. The process then returns to the block 425 waiting for a next review command from the clients. With reference again to the swim-lane of the client, the control agent at block 428 receives the review response from the control server (and it extracts the control information). The control agent at block 429 displays a report based on the control information on the monitor of the client. For example, the report includes a row for each entry retrieved from the control database, which row contains the descriptor of the primary server, the type identifiers of the personal information submitted thereto, the time-stamp of its submission and the corresponding confirmation flag; the row has a sub-row for each secondary server with which the personal information may have been shared, which sub-row contains its descriptor and the corresponding confirmation flag. In this way, the user has a complete overview of the personal information which has been disseminated, who has been authorized to use it, either directly (primary servers) or indirectly (secondary servers). Moreover, the user may select one or more primary/secondary servers for updating their use authorizations, that is, by revoking or confirming them. The flow of activity branches at block 430 according to a behavior of the user. If the user has requested any update of one or more use authorizations, a corresponding update procedure is called at block 431 for each of them. The update procedure (described in the following) is called by passing the network address of the selected (primary/secondary) server, the network address of the corresponding primary server and an update indicator; the update indicator specifies a type of the update which has been requested by the user (revocation or confirmation). The process then returns from the block 431 or directly from the block 430 (if the user has requested no update of use authorizations) to the block 423 waiting for a next review request.

In a completely independent way, the communication agent at block 432 receives a message from a generic sender server (for example, an e-mail, an instant message, an SMS and so on). In response thereto, the communication agent at block 433 displays the message on the monitor of the client as usual. At the same time, the message monitor at block 434 intercepts the message (for example, with hoking techniques). The message monitor at block 435 commands the detection engine to analyze the message (and particularly its content, for example, extracted from a body of the message). For this purpose, the detection engine verifies as above whether every part of the message (for example, one or more adjacent words) matches any of the reference rules (indicated in the detection policy repository). The flow of activity branches at block 436 according to a result of this verification. If the message contains one or more parts each satisfying reference rules, meaning that they match the corresponding (matched) detection policies, the process descends into block 437. At this point, the message monitor commands the control agent to build an investigation command for the control server; the investigation command includes the client identifier of the client (retrieved as above), the network address of the sender server (from which the message has been received) and the type identifiers comprised in the matched detection policies. The control agent then sends the investigation command to the control server. In this case, the message is identified as potentially suspect automatically (since containing personal information of the user). In addition or in alternative, the same point is also reached from block 438 if the control agent receives an investigation request entered manually by the user for investigating the message (for example, when undesired). In this case, the control agent directly builds the investigation command (only comprising the client identifier and the network address of the sender server) and sends it as above to the control server. In this way, the message may be identified as potentially suspect manually (even when it does not contain personal information explicitly). Moving to the swim-lane of the control server, the control manager at block 439 receives the investigation command from the client (and it extract the client identifier, the network address of the sender server and the possible type identifiers). The control manager at block 440 retrieves the user identifier associated with the client identifier (from the user database). The control manager then builds a corresponding investigation response. Particularly, the control manager looks for any (matching) entries in the control database containing the network address of the sender server and the same type identifiers, if any. For each matching entry, if the confirmation flag is not asserted the control manager adds, to the investigation response, the descriptor of the primary/secondary server whose network address matches the one of the sender server, the network address and the descriptor of the primary server, the type identifiers and the time-stamp (whereas the matching entry is skipped if the confirmation flag is asserted). Optionally, the control manager calculates a probability indicator of the association of the sender server with the primary server (for example, from 0 to 1) and adds it to the investigation response as well. The probability indicator is set to 1 when the sender server and the primary server are the same; otherwise, the probability indicator is calculated according to one or more similarity rules based on subject-matters dealt with by the sender server and by the primary server, retrieved via corresponding queries submitted to a search engine (for example, in case of a sender server dealing with dwelling insurances the probability index is high for a primary server dealing with loans and it is low for a primary server dealing with electronic devices). The control manager at block 441 sends the investigation response back to the client. The process then returns to the block 439 waiting for a next investigation command from the clients. With reference again to the swim-lane of the client, the control agent at block 442 receives the investigation response from the control server (and it extracts the descriptor of the sender server, the network address and the descriptor of the primary server, the type identifiers, the time-stamp and the possible probability indicator). The flow of activity branches at block 443 according to the investigation response. If the investigation response is not empty, the control agent at block 444 displays a corresponding alert on the monitor of the client. For example, the alert includes the descriptor of the sender server and, for each primary server, its descriptor, the type identifiers, the time-stamp and the possible probability indicator. In this way, the user may understand how the sender server has been authorized to use the personal information; this happens only when the corresponding use authorization has not been confirmed (confirmation flag deasserted), so as to avoid useless alerts. Moreover, the user may select one or more primary servers for causing them to update the use authorizations for the sender server. The flow of activity branches at block 445 according to a behavior of the user. If the user has requested any update of one or more use authorizations, the same update procedure mentioned above is called at block 446 for each of them. The update procedure (described in the following) is called by passing the network address of the sender server, the network address of the primary server and the update indicator as above (revocation/confirmation). The process then returns from the block 446 or directly from the block 436 (if the message does not satisfy any of the reference rules), from the block 443 (if the investigation response is empty) or from the block 445 (if the user has requested no update of the use authorizations) to the block 432 waiting for a next message.

The update procedure called at the block 431 or at the block 446 starts at block 447 (receiving the network address of the selected/sender server, the network address of the primary server and the update indicator). The flow of activity branches at block 448 according to the update indicator. If the update indicator specifies that the user has requested the revocation of the use authorization, the control agent at block 449 requests (via the browser) a corresponding (on-line) revocation form to the primary server. Moving to the swim-lane of the primary server, the web application at block 450 receives the request for the revocation form (via the web server). In response thereto, the web application at block 451 retrieves the revocation form (for example, by fetching a corresponding web page) and downloads it to the client (via the web server). The process then returns to the block 450 waiting for a next request of the revocation form. Going back to the swim-lane of the client, the browser at block 452 receives the revocation form from the primary server. In this phase, the control agent may also intercept the revocation form and automatically fill it, by selecting an option for removing the use authorization to the primary server (when the selected/sender server is the same as the primary server) or for removing the authorization to share the use authorization with the selected/sender server (when the selected/sender server is different from the primary server meaning that is a secondary server thereof). In any case, the browser at block 453 displays the (possibly filled-in) revocation form on the monitor of the client. The user may then review the revocation form (particularly, for adding its user identifier with the primary server and the above-mentioned information if not inserted automatically) and submits it to the primary server (for example, by clicking a submit button). In this way, the user may request the revocation of the desired use authorization in a straightforward way. In response thereto, the browser at block 454 sends a corresponding revocation command (built according to the content of the revocation form) to the primary server. Moving again to the swim-lane of the primary server, the web application at block 455 receives the revocation command (via the web server) and processes it as usual. Particularly, the flow of activity branches at block 456 according to a request of the user. If the user has requested to revoke the use authorization from the primary server, the web application at block 457 updates the personal information database accordingly by deleting the whole entry of the user identifier (comprising his/her personal information). The process then returns to the block 455 waiting for a next revocation command. Conversely, if the user has requested to revoke the use authorization to share the use authorization with a secondary server the web application at block 458 updates the personal information database accordingly by deleting the network address of the secondary server from the entry of the user identifier. Moreover, the web application at block 459 sends a corresponding revocation command (comprising the user identifier) to the secondary server (via the web server). In this case as well, the process then returns to the block 455 waiting for a next revocation command. Moving to the swim-lane of the secondary server, the distribution application at block 460 receives the revocation command. In response thereto, the distribution application at block 461 updates the personal information database accordingly by deleting the whole entry of the user identifier (comprising his/her personal information). The process then returns to the block 460 waiting for a next revocation command. With reference again to the swim-lane of the client, the process continues from the block 454 to block 462; the same point is also reached directly from the block 448 if the update indicator specifies that the user has requested the confirmation of the use authorization. At this point, the control agent builds an update command for the control server. The update command includes the client identifier (retrieve as above), the network address of the primary server, the network address of the selected/sender server and the update indicator. The control agent then sends the update command to the control server. The process now returns to the block 447 waiting for a next call of the revocation procedure. Moving to the swim-lane of the control server, the control manager at block 463 receives the update command from the client (and it extracts the client identifier, the network address of the primary server, the network address of the selected/sender server and the update indicator). The control manager at block 464 updates the control database accordingly. Particularly, the control manager retrieves the user identifier associated with the client identifier (from the user database). If the update indicator specifies that the user has requested the revocation of the use authorization, when the selected/sender server is the same as the primary server (meaning that the selected/sender server is a primary server) the control manager deletes the whole entry of the user identifier and the primary server from the control database, whereas when the selected/sender server is different from the primary server (meaning that the selected/sender server is a secondary server of the primary server) the control manager deletes the sub-entry of the secondary server from the entry of the user identifier and the primary server in the control database. Conversely, if the update indicator specifies that the user has requested the confirmation of the use authorization, the control manager asserts the confirmation flag of the selected/sender server in the entry of the user identifier and the primary server in the control database. The process then returns to the block 463 waiting for a next update command.

For example, the user may have submitted the personal information to a bank during a process to obtain a loan for buying a new house (authorizing the bank to use the personal information and to share it). After a while, the user receives a message from an unknown insurance agency advertising an insurance for a house tailored on the user (for example, based on his/her age). The user may be annoyed by the fact that the insurance agency knows and uses his/her personal information (that is, the age in this case), but s/he is completely unaware of how the insurance agency managed to obtain the personal information. In the above-described solution, instead, the user may find out that the insurance agency has obtained the personal information from the bank, and s/he may ask it to revoke the corresponding use authorization directly. Conversely, if the user is interested in insuring the new house s/he may confirm the use authorization of the insurance agency; in this case, the user will continue to receive messages from it (without any more alerts).

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, the terms “substantially”, “about”, “approximately” and the like should be understood as “within 10%”. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (that is, not limited to the recited items), the terms based on, dependent on, according to, function of and the like should be intended as a non-exclusive relationship (that is, with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for controlling use of information. However, the information may be of any type (for example, texts, audios, images, videos and so on).

In an embodiment, the method includes the following steps executed by a control computing system. However, the control computing system may be of any type (see below).

In an embodiment, the method includes detecting (by the control computing system) corresponding relevant information contained in corresponding information submitted to each of one or more primary computing systems. However, the information may be submitted to any number and type of primary computing systems (see below), and the corresponding relevant information may be of any type (for example, personal information, sensitive information, commercial and/or technical information of industrial products/processes, and so on).

In an embodiment, the relevant information is detected according to one or more detection policies. However, the detection policies may be in any number and of any type (for example, based on labels associated with the information, on the content of the information itself, and so on).

In an embodiment, each of the primary computing systems has been granted a use authorization for the corresponding relevant information. However, the use authorization may have been granted in any way (for example, before, together with or after the submission of the relevant information, indiscriminately or for specific purposes only, and so on).

In an embodiment, each of the primary computing systems has been authorized to transfer the use authorization to one or more corresponding secondary computing systems. However, the authorization to transfer the use authorization may have been granted in any way (together or separately from the grant of the use authorization to the primary computing system, in a way either the same or different with respect to above, and so on) to any number and type of secondary computing systems (see below), indiscriminately, by categories, individually, and so on.

In an embodiment, the method includes determining (by the control computing system) the corresponding secondary computing systems of each of the primary computing systems from an authorization memory structure associated with the primary computing system. However, the authorization memory structure may be of any type (for example, a database, a file and so on) and it may be associated with the primary computing system in any way (for example, stored therein, available at a corresponding link, and so on).

In an embodiment, the method includes causing (by the control computing system) a storing of an indication of each of the primary computing systems, of the corresponding relevant information and of the corresponding secondary computing systems into a control memory structure. However, the control memory structure may be of any type (for example, a database, a file and so on), it may be stored anywhere (for example, in the client, in the control server and so on) and it may indicate the primary/secondary computing systems and the relevant information in any way (for example, by their network addresses, names and so on and by its types, contents and so on, respectively, with or without additional information, such as corresponding time-stamps, confirmation flags, identifiers of the clients used to grant the use authorizations, and so on).

In an embodiment, the method includes controlling (by the control computing system) a use of the relevant information by the primary computing systems and the secondary computing systems according to the control memory structure. However, the use of the relevant information may be controlled in any way (for example, in response to review requests, to undesired messages, and so on).

In an embodiment, the relevant information is personal information of a person. However, the personal information may be of any type (for example, any piece of information that may be used to distinguish or trace the person, such as name, social security number, date and place of birth, photos, biometric records, any piece of information which may be linked to the person, such as medical, educational, financial or employment conditions, client's network addresses, social accounts, and so on).

In an embodiment, the method includes displaying (by the control computing system) corresponding online forms downloaded from the primary computing systems. However, the on-line forms may be of any type (for example, web pages, files and so on).

In an embodiment, each of the online forms contains one or more input fields associated with corresponding input indicators for entering the corresponding information. However, the input fields may be in any number and of nay type (for example, input boxes, check boxes and so on) and the corresponding input indicators may be of any type (for example, input labels displayed close to them, explanation texts available to be displayed, such as in pop-up windows, names of corresponding controls/variables, and so on).

In an embodiment, the method includes submitting (by the control computing system) the information being entered into the input fields of each of the online forms to the corresponding primary computing system. However, the information may be submitted in any way (for example, by sending a command, uploading a file, and so on).

In an embodiment, the method includes determining (by the control computing system) the relevant information contained in the information entered in each of the online forms according to the corresponding input indicators. However, the relevant information may be determined in any way (for example, by applying string search techniques, such as based on exact/fuzzy matching criteria, concept search techniques, and so on).

In an embodiment, the method includes determining (by the control computing system) the relevant information contained in the information submitted to each of the primary computing systems according to one or more reference rules applied to the information. However, the reference rules may be in any number and of any type (for example, based on dictionaries, regular expressions, heuristics, and so on).

In an embodiment, the method includes receiving (by the control computing system) a message from a sender computing system of the primary computing systems or the secondary computing systems. However, the message may be of any type (for example, an e-mail, an instant message, an SMS, a pop-up, a banner, and so on) and it may be received in any way (for example, in push mode, in pull mode, within a web page, and so on).

In an embodiment, the method includes retrieving (by the control computing system) the indication of a current one of the primary computing systems associated with the sender computing system from the control memory structure. However, the current primary computing system may of any type (for example, a single one, a list of candidates ones with or without any corresponding probability indicators), and it may be retrieved in any way (for example, by sending a remote command, executing a local query, and so on) in response to any event (for example, the detection of personal information in the message, a manual request, the sender server being unknown, such as not comprised in a personal address book or in bookmarks, and so on).

In an embodiment, the method includes outputting (by the control computing system) an alert comprising the indication of the current primary computing system. However, the alert may be output in any way (for example, by displaying a message, uttering a vocal message, and so on) and it may contain the indication of the current primary computing system only or any additional information (for example, the type indicators of the corresponding personal information, the time-stamp of the granting of the corresponding use authorization, and so on).

In an embodiment, the method includes detecting (by the control computing system) current one of the relevant information contained in the message. However, the current relevant information may be detected in any way (either the same or different with respect to the detection of the relevant information contained in the information submitted to the primary computing systems).

In an embodiment, the method includes retrieving (by the control computing system) the indication of the current primary computing system associated with the current relevant information and the sender computing system from the control memory structure in response to said detecting the current relevant information. However, the current primary computing system may be determined according to the current relevant information in any way (for example, when all the current relevant information is contained in the relevant information which the current primary computing system is authorized to use, when this is true for at least part of the current relevant information only, and so on).

In an embodiment, the method includes requesting (by the control computing system) the current primary computing system to update the use authorization of the sender computing system. However, the update may be of any type (for example, revoking the use authorization, confirming the use authorization, indiscriminately or for the current relevant information only, and so on) and it may be requested in any way (for example, with a remote command, an on-line form, and so).

In an embodiment, the method includes updating (by the control computing system) the authorization memory structure according to said update of the use authorization of the sender computing system. However, the authorization memory structure may be updated in any way (for example, with a remote command, a local instruction, and so on).

In an embodiment, said update of the use authorization of the sender computing system is a revocation thereof. However, the revocation may be of any type (for example, complete, for specific uses only, requesting the deletion of the corresponding relevant information too, and so on).

In an embodiment, said update of the use authorization of the sender computing system is a confirmation thereof. However, the confirmation may be of any type (for example, complete, for specific uses only, and so on).

In an embodiment, said outputting the alert is prevented in response to the use authorization of the sender computing system being confirmed. However, the prevention of the alert may be of any type (for example, forever, for a certain period, and so on) or it may be omitted at all.

In an embodiment, the method includes retrieving (by the control computing system) control information containing the indication of at least part of the primary computing systems, of the corresponding relevant information and of the corresponding secondary computing systems from the control memory structure. However, the control information may be of any type (for example, relating to all the primary computing systems, to part of them selected in any way, with or without additional information, such as the corresponding time-stamps, and so on) and it may be retrieved in any way (for example, by sending a remote command, executing a local query, and so on).

In an embodiment, the method includes outputting (by the control computing system) a report based on the control information. However, the report may be output in any way (for example, by displaying a table, opening a document, printing a list, and so on).

In an embodiment, the method includes receiving (by the control computing system) a selection from the report of a selected computing system of the primary computing systems or the secondary computing systems. However, the selected computing system may be chosen in any way (for example, individually, in-group, and so on).

In an embodiment, the method includes determining (by the control computing system) the indication of a current one of the primary computing systems associated with the selected computing system from the control information. However, the current primary computing system may be determined in any way (for example, with a command, a query, and so on).

In an embodiment, the method includes requesting (by the control computing system) the current primary computing system to update the use authorization of the selected computing system. However, the update may be of any type and it may be requested in any way (either the same or different with respect to the sender computing system).

In an embodiment, the method includes updating (by the control computing system) the authorization memory structure according to said update of the use authorization of the selected computing system. However, the authorization memory structure may be updated in any way (either the same or different with respect to the sender computing system).

In an embodiment, said update of the use authorization of the selected computing system is a revocation thereof. However, the revocation may be of any type (either the same or different with respect to the sender computing system).

In an embodiment, said update of the use authorization of the selected computing system is a confirmation thereof. However, the confirmation may be of any type (either the same or different with respect to the sender computing system).

In an embodiment, the method includes performing said detecting the relevant information by one or more client computing systems of a person. However, the client computing systems may be in any number and of any type (see below); in any case, the possibility is not excluded of performing this operation by a server computing system (for example, by sending it the submitted information, the empty submission form, and so on).

In an embodiment, the method includes storing, by a server computing system, the indication of each of the primary computing systems, of the corresponding relevant information and of the corresponding secondary computing systems into the control memory structure in association with the person. However, the server computing system may be any type (see below) and the corresponding information may be associated with each person in any way (for example, in dedicated records of a single memory structure or in dedicated memory structures, in association with an identifier of the person or with an identifier of each client computing system thereof, and so on); in any case, the possibility is not excluded of storing the authorization memory structure locally (in each client computing system).

Generally, similar considerations apply if the same solution is implemented with an equivalent method (by using similar steps with the same functions of more steps or portions thereof, removing some non-essential steps or adding further optional steps); moreover, the steps may be performed in a different order, concurrently or in an interleaved way (at least in part).

An embodiment provides a computer program which is configured for causing a control computing system to perform the above-mentioned method. An embodiment provides a computer program product for controlling use of information. The computer program product includes a computer readable storage medium that has program instructions embodied therewith. The program instructions are executable by a control computing system to cause the control computing system to perform the above-mentioned method. However, the computer program may be implemented as a stand-alone module, as a plug-in for a pre-existing software program (for example, the browser) or directly therein. Moreover, the computer program may be executed on any control computing system (see below). In any case, the solution according to an embodiment of the present disclosure lends itself to be implemented even with a hardware structure (for example, by electronic circuits integrated in one or more chips of semiconductor material), or with a combination of software and hardware suitably programmed or otherwise configured.

An embodiment provides a control computing system comprising means that are configured for performing the steps of the above-described method. An embodiment provides a control computing system comprising a circuit (that is, any hardware suitably configured, for example, by software) for performing each of the steps of the same method. However, the control computing system may be of any type (for example, a client computing system, a server computing system, a combination of one or more client computing systems and a server computing system, and so on). Moreover, each client computing system may be of any type (for example, a desktop, a laptop, a tablet, a smartphone and so on), the server computing system may be of any type (for example, a physical machine, a virtual machine, a cloud service, and so on), and they may communicate over any network (for example, a local area, wide area, global, mobile or satellite network) using any kind of connections (wired or wireless).

Generally, similar considerations apply if the control computing system has a different structure or includes equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the person's computer, partly on the person's computer, as a stand-alone software package, partly on the person's computer and partly on a remote computer or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some embodiments of the present invention may include one, or more, of the following features, characteristics, operations and/or advantages: (i) interception of sensitive data provided by the user of a web application and the storing of peculiar information for further processing; (ii) the visualization of where the data is stored; (iii) the capability to prompt the specified internet site page from where the user wants his/her data to be removed; (iv) software is installed and running in the background on the user device (from now on called agent application), whose scope is to intercept the HTML page in the foreground only when the user types in data; and/or (v) the empty page is sent to a cognitive application on the server which will analyze the HTML form and identify if the form contains personal info (such as, name, age, address, phone number).

In some embodiments, there are 2 possible levels of complexity scenarios (eventually configured/customized by the user) which will be described in the following two paragraphs.

In one complexity level, the empty HTML form is sent to the server for analysis (text analyzer). The software parses the HTML labels in order to find text fields where the user has written his own sensible data (that is, ‘name’, ‘address’, ‘credit card number’). The HTML form, including parsing the data typed by the user, is parsed so as to evaluate if eventual personal data has been typed in the form of free text. Heuristics is used for parsing such data in free text (like dictionaries for names, regular expressions for other sensible data).

In a second complexity level, the application running as a plugin of the browser identifies if any personal info in the form is being analyzed and identifies the personal data, even when the free text entries are properly configured by the user. If personal data is identified, such data is stored in a server database which sends back a message to the agent application which will store the data locally on the device. The internet link of the displayed page, and any other information which can identify who is storing the data, may also include third party software. This third party software is known to collaborate to the web site, which can store and/or reuse such data.

In some embodiments, this information can later be examined by the user and/or the agent. The application can provide a summary report at a pre-configured user frequency. When an email, or other kind of data arrives to any of the user's devices, the agent application will try to relate the external data (advertising mails, messages, address, industry type) and the sender, with the entity owning personal data. The data is stored by the application which includes where and when personal data has been sent and will also associate a probabilistic value to the results.

In some embodiments, the user can then choose to remove the personal data from the specified site(s) or confirm the relation (to validate the relation). If the user decides to exercise the right to be forgotten, the agent application will prompt the user to the internet site page for data removal processing.

What is claimed is:

1. A method for controlling use of information, wherein the method comprises:
detecting, by a control computing system, corresponding relevant information contained in corresponding information submitted to each of one or more primary computing systems according to one or more detection policies, each of the primary computing systems being granted a use authorization for the corresponding relevant information and being authorized to transfer the use authorization to one or more corresponding secondary computing systems,
determining, by the control computing system, the corresponding secondary computing systems of each of the primary computing systems from an authorization memory structure associated with the primary computing system,
causing, by the control computing system, a storing of an indication of each of the primary computing systems, of the corresponding relevant information and of the corresponding secondary computing systems into a control memory structure, and
controlling, by the control computing system, a use of the relevant information by the primary computing systems and the secondary computing systems according to the control memory structure.

2. The method according to claim 1, wherein the relevant information is personal information of a person.

3. The method according to claim 1, wherein the method comprises:
displaying, by the control computing system, corresponding online forms downloaded from the primary computing systems, each of the online forms containing one or more input fields associated with corresponding input indicators for entering the corresponding information,
submitting, by the control computing system, the information being entered into the input fields of each of the online forms to the corresponding primary computing system, and
determining, by the control computing system, the relevant information contained in the information entered in each of the online forms according to the corresponding input indicators.

4. The method according to claim 1, wherein the method comprises:
determining, by the control computing system, the relevant information contained in the information submitted to each of the primary computing systems according to one or more reference rules applied to the information.

5. The method according to claim 1, wherein the method comprises:
receiving, by the control computing system, a message from a sender computing system of the primary computing systems or the secondary computing systems,
retrieving, by the control computing system, the indication of a current one of the primary computing systems associated with the sender computing system from the control memory structure, and
outputting, by the control computing system, an alert comprising the indication of the current primary computing system.

6. The method according to claim 5, wherein the method comprises:
detecting, by the control computing system, current one of the relevant information contained in the message, and
retrieving, by the control computing system, the indication of the current primary computing system associated with the current relevant information and the sender computing system from the control memory structure in response to said detecting the current relevant information.

7. The method according to claim 5, wherein the method comprises:
requesting, by the control computing system, the current primary computing system to update the use authorization of the sender computing system, and
updating, by the control computing system, the authorization memory structure according to said update of the use authorization of the sender computing system.

8. The method according to claim 7, wherein said update of the use authorization of the sender computing system is a revocation thereof.

9. The method according to claim 7, wherein said update of the use authorization of the sender computing system is a confirmation thereof, said outputting the alert being prevented in response to the use authorization of the sender computing system being confirmed.

10. The method according to claim 1, wherein the method comprises:
retrieving, by the control computing system, control information containing the indication of at least part of the primary computing systems, of the corresponding relevant information and of the corresponding secondary computing systems from the control memory structure, and
outputting, by the control computing system, a report based on the control information.

11. The method according to claim 10, wherein the method comprises:
receiving, by the control computing system, a selection from the report of a selected computing system of the primary computing systems or the secondary computing systems,
determining, by the control computing system, the indication of a current one of the primary computing systems associated with the selected computing system from the control information,
requesting, by the control computing system, the current primary computing system to update the use authorization of the selected computing system, and
updating, by the control computing system, the authorization memory structure according to said update of the use authorization of the selected computing system.

12. The method according to claim 11, wherein said update of the use authorization of the selected computing system is a revocation thereof.

13. The method according to claim 11, wherein said update of the use authorization of the selected computing system is a confirmation thereof, the method comprising:
receiving, by the control computing system, a message from a sender computing system of the primary computing systems or the secondary computing systems,
retrieving, by the control computing system, the indication of a further current one of the primary computing systems associated with the sender computing system from the control memory structure, and
outputting, by the control computing system, an alert comprising the indication of the further current primary computing system if the use authorization of the sender computing system is not confirmed.

14. The method according to claim 1, wherein the method comprises:
performing said detecting the relevant information by one or more client computing systems of a person.

15. The method according to claim 14, wherein the method comprises:
storing, by a server computing system, the indication of each of the primary computing systems, of the corresponding relevant information and of the corresponding secondary computing systems into the control memory structure in association with the person.

16. A computer program product for controlling use of information, the computer program product comprising a computer readable storage medium having program instructions embodied therewith, the program instructions readable by a control computing system to cause the control computing system to perform a method comprising:
detecting corresponding relevant information contained in corresponding information submitted to each of one or more primary computing systems according to one or more detection policies, each of the primary computing systems being granted a use authorization for the corresponding relevant information and being authorized to transfer the use authorization to one or more corresponding secondary computing systems,
determining the corresponding secondary computing systems of each of the primary computing systems from an authorization memory structure associated with the primary computing system,
causing a storing of an indication of each of the primary computing systems, of the corresponding relevant information and of the corresponding secondary computing systems into a control memory structure, and
controlling a use of the relevant information by the primary computing systems and the secondary computing systems according to the control memory structure.

17. The CPP of claim 16 further comprising a processor(s) set structured, programmed and/or connected to perform the program instructions, wherein the CPP is in the form of a control computer system.

18. A method comprising:
for each given primary computing system of a plurality of primary computing systems, granting a use authorization to the given primary computing system, with the use authorization including a definition of relevant information to which the use authorization is applicable and any authorization(s) to transfer the first use authorization to a secondary computing system of a plurality of secondary computing systems;
for each given use authorization of the plurality of use authorizations respectively corresponding to the plurality of primary computing systems, storing the given use authorization in a control memory structure included in a control computing system; and
controlling, by the control computing system, use of information by the plurality of primary computing systems and the plurality of secondary computing systems according to the use authorizations stored in the control memory structure.

19. The method of claim 18 wherein the definitions of relevant information in each use authorization of the plurality of use authorizations are based on data protection regulations.

20. The method of claim 19 wherein the data protection regulations include the General Data Protection Regulation (GDPR).
